(19) United States
(12) Patent Application Publication
(10) Pub. No.: US 2009/0013004 A1
(43) Pub. Date: Jan. 8, 2009

(54) System and Method for the Characterization, Selection and Recommendation of Digital Music and Media Content

(75) Inventors: Avet Manukyan, Yerevan (AM); Vartan Sarkissian, London (GB)

Correspondence Address: MANATT PHELPS AND PHILLIPS;ROBERT D. BECKER, 1001 PAGE MILL ROAD, BUILDING 2, PALO ALTO, CA, 94304, US

(73) Assignee: Rockbury Media International, C.V., Amsterdam (NL)

(21) Appl. No.: 12/168,754

(22) Filed: Jul. 7, 2008

Related U.S. Application Data
(60) Provisional application No. 60/948,173, filed on Jul. 5, 2007.

(51) Int. Cl. G06F 17/30

(52) U.S. Cl. 707/104.1; 707/E17.044

(57) ABSTRACT

The present inventions relate to systems and methods for characterizing, selecting, and recommending digital music and content to users. More particularly, the present invention discloses a song recommendation engine which uses mathematical algorithms to analyze digital music compositions for determining characteristics of the song, matching the analysis to a user's tastes and preferences, and recommending a song based on relative comparability of a user's desired musical characteristics.

### RELATED APPLICATIONS

The present application claims the benefit of and priority to provisional patent application 60/948,173 entitled “System and Method for the Characterization, Selection and Recommendation of Digital Music and Media Content,” filed Jul. 5, 2007, and is hereby incorporated by reference.

### FIELD OF THE INVENTION

The present invention relates to systems and methods for characterizing, selecting, and recommending digital music and content to users. More particularly, the present invention disclosed herein relates to a song recommendation engine which uses mathematical algorithms to analyze digital music compositions for determining characteristics of the song, matching the analysis to a user's tastes and preferences, and recommending a song based on relative comparability of a user's desired musical characteristics.

### BACKGROUND OF THE INVENTION

With the proliferation of Internet access and broadband data connections to the general public, there has been a corresponding increase in the growth of the online distribution of digital content, including music files, video files and other digital media. Over the past few years, downloading digital music online has become increasingly popular. With improvements in computer technology and the ever-expanding capabilities of MPEG-1 Audio Layer 3 (MP3s) players, this segment of the music industry continues to grow over traditional channels for music distribution and sales.

With an ever increasing number of songs and musical compositions available online, it may be difficult for a music shopper to find additional content that she may enjoy. The amount of information online far exceeds an individual user's ability to wade through it, but computers can be tapped to lead people to what might otherwise be undiscovered content. There is a longstanding attempt to use technological tools to take over where a friend's recommendations, reviewers or other traditional opinions leave off. Therefore, there is a need for a music recommendation system to assist users in finding songs that match their preferences or musical tastes and discover new music.

### BRIEF SUMMARY OF THE INVENTION

One important aspect of the invention rests on the features of songs, their similarity and a user's personalized psychoacoustic models. In one embodiment of the invention, the system and method creates a psychoacoustic model for an individual user representing the user's musical taste and behavior in choosing songs. Based on an analysis of a wide variety of psychoacoustic models and song features, the recommendation system and method determine the interrelations between songs' features and the user's attitude towards each of those features. The term song can be used interchangeably with any media that contains audio content in any form, including but not limited to music, audio tracks, albums, compact discs (CDs), samples, and MP3s.

In one embodiment of the invention, the psychoacoustic models are based on two interrelated mathematical analysis: a non-personal analysis based on a given song's features; and a personal analysis, on based on the user's preferences. The non-personal analysis is the objective aspect of the recommendation. It analyzes each given song and divides the song based on the songs' features or parameters. These parameters, or set of parameters, are unique for each song.

The personal analysis is the subjective aspect of recommendation. It collects information about the user's musical taste. In one embodiment of the invention, the recommendation system and method suggest that a user listen to several songs, and subsequent to listening to those songs, providing a rating, ranking or comments on each of the songs.

Based on the information obtained from either the non-personal analysis, personal analysis, or both analyses, the user's individual psychoacoustic model is created. In comparison with other known music recommendation services, the recommendation systems and methods described herein are more efficient and reliable service because of the new mathematical analysis methods and algorithms utilized.

Accordingly, the present invention provides systems and methods for characterizing, selecting, and recommending digital music and content to users. Utilizing discrete techniques and algorithms, the recommendation system (or “recommendation engine”) is a tool that characterizes the digital composition of a song and enables the recommendation of music to a user based on a limited set of information about that user's preferences.

In one embodiment of the present invention, the analysis of the audio content includes a fingerprinting of the song's structure. The recommendation engine makes use of a technique and a series of algorithms to perform digital fingerprinting of the content. In performing the fingerprinting, the audio content (a track or song, for example) is divided into several overlapped frames with duration of milliseconds when transposed to real time. These frames are processed with transforms to determine the self-similarity matrix for all frames. A statistical analysis of the self-similarity results for each frame is used to generate an index which is unique for each song, track or sample.

In another embodiment of the present invention, the analysis of the audio content includes detection of a song's characterizing segments. The recommendation engine makes use of a technique to determine characteristic features of the track, song or sample. In this technique, the audio content is processed as in the fingerprinting analysis described above. The self-similarity matrix for all analyzed frames is reformed into a Boolean matrix which is treated with erosion and dilation algorithms. A subsequent algorithm is used to determine a number (indeterminate number ‘n’) of repetitive or characteristic segments (which contain several continuous frames). Each of these segments is represented as an array of audio features. This is achieved by dividing each segment into several half-overlapped frames of ‘τ’ seconds, the set of features being calculated for each frame. This results in a matrix for each segment which represents the audio feature rates for the particular segments' frames and the order of those frames.

In yet another embodiment of the present invention, the analysis of the audio content includes identification of a song's features based on its coherence vector map. The recommendation engine makes use of a method whereby the determination and detection of similar segments within an audio track, song or sample can be simplified and the resultant determination is computationally substantially more efficient. The initial representation of the set of features obtained using fingerprinting analysis and segment characterization above is represented as a point in N-dimensional space. Polar representation is possible by transformation such that each point corresponds to the set of angles which are formed by the features' coordinate curves and the line linking the grid origin and the corresponding point in N-dimensional space. As a result, the points describing similar frames are found to be in immediate proximity to each other on the polar representation.

It will be appreciated that additional features and advantages of the present invention will be apparent from the following descriptions of the various embodiments when read in conjunction with the accompanying drawings. It will be understood by one of ordinary skill in the art that the following embodiments are provided for illustrative and exemplary purposes only, and that numerous combinations of the elements of the various embodiments of the present invention are possible.

### BRIEF DESCRIPTION OF THE DRAWINGS

FIGS. 1(A-D) are exemplary matrices obtained from an analysis of a song's audio content based on a fingerprinting of the song's structure in accordance with one embodiment of the present invention.

FIGS. 2(A-D) are exemplary matrices obtained from an analysis of a song's audio content based on a detection of a song's characterizing segments in accordance with one embodiment of the present invention.

### DETAILED DESCRIPTION OF PREFERRED EMBODIMENTS OF THE INVENTION

Various embodiments of the invention are described hereinafter with reference to the figures. It should also be noted that the figures are only intended to facilitate the description of specific embodiments of the invention. The embodiments are not intended as an exhaustive description of the invention or as a limitation on the scope of the invention. In addition, an aspect described in conjunction with a particular embodiment of the invention is not necessarily limited to that embodiment and can be practiced in any other embodiment of the invention. While the present invention is described in conjunction with applications for music content, it is equally applicable to other forms of digital content, including image and audio/visual files.

In accordance with one embodiment of the invention, a designated song is divided into multiple 80% overlapped frames of 128 milliseconds. Each frame contains about 512 audio samples. For deriving the spectral energy of each frame, the Fast Fourier Transform (FFT) algorithm is used. FFT is intended for infinite functions so it may distort the initial and final parts of the frame's signal. In order to avoid the distortion, each frame is multiplied by a window function (for example, the Blackman function is used) before using FFT. The obtained Fourier series is broken up into 36 melbank coefficients (according to 3 octaves of 7 music notes and 5 sharps). Therefore, each frame is reformed into an array with 36 float elements.

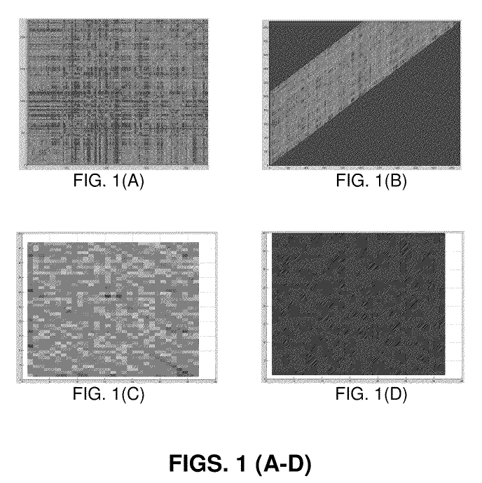

Turning now to the drawings, FIGS. 1(A-D) are exemplary matrices obtained from an analysis of a song's audio content based on a fingerprinting of the song's structure. The obtained arrays are processed with special comparison algorithms which creates a Self-Similarity Matrix (S_{i,j}). The rates of similarity of each frame in comparison with all other frames are represented in the matrix shown in FIG. 1(A). Darker points represent more similar musical frames. In essence, the self-similarity matrix is a symmetric two-dimensional array, reflective around the diagonal axis. That is why only the elements upper to the main diagonal (hereinafter “Upper Matrix”) are considered in subsequent calculations.

The Upper Matrix is reformed into Triangular time-lag Matrix where T_{i,k}=S_{i,i+k}, wherein T matrix's part only where i≦1056 frames (equal to 27 seconds). The elements of shorted T matrix are then aggregated. Each (33×33) sub-array will be reformed into one element by using an averaging algorithm. Resulting (32×N) matrix (hereinafter “Averaged Matrix”) is shown in FIG. 1(B).

The Averaged Matrix is reformed into a Boolean Matrix due to the adjustable thresholds for each of the (8×8) sub-arrays, which are determined so that only 24.9% of the certain sub-array's elements can be higher than the chosen threshold, as shown in FIG. 1(C). As a result, the Boolean Matrix, as shown in FIG. 1(D) can be considered a vector of N elements of 32-bit binary numbers (unsigned integers).

This obtained vector is the “fingerprint index” for the designated song. The “fingerprint index” is used by the recommendation engine for direct comparison of a song's “fingerprinting index” with other existing “indexes” already in the database.

In accordance with another embodiment of the invention, in order to detect the characterizing/repetitive segments of a designated song, conventional features representing the music notes are extracted. The Constant Q Transform (CQT) algorithm is used to achieve this goal. The CQT algorithm has the ability to represent musical signals as a sequence of exact musical notes. This approach covers musical pitches (7 notes and 5 sharps) in 3 octaves. As a result, 36 semi-notes are extracted from each continuous frame of the song (113 ms). Each frame is inverted into an array with 36 float elements representing the spectral energy of each note.

The obtained CQT arrays are processed with comparison algorithms which creates a Self-Similarity Matrix (S={s_{i,j}}) using a distance measure dependent on the structure of difference array.

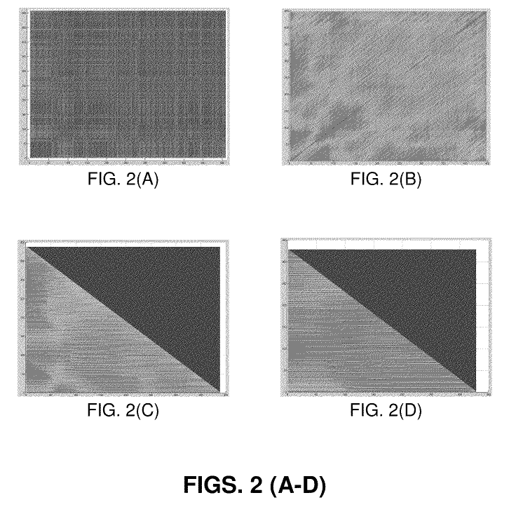

FIGS. 2(A-D) are exemplary matrices obtained from an analysis of a song's audio content based on a detection of a song's characterizing segments. The rates of similarity of each frame in comparison with all other frames are represented in the matrix shown in FIG. 2(A). Darker points represent more similar musical frames.

Each element of the matrix is averaged up to ‘N’ number of neighbor elements which form lines parallel to the main diagonal. The Averaged Matrix shows several lines (repetitive segments) parallel to the main diagonal, as shown if FIG. 2(B). In this example, both the self-similarity and the averaged matrixes are symmetric two-dimensional arrays. For this reason, only the elements above the main diagonal (hereinafter “Upper Matrix”) are considered in subsequent calculations.

The Upper Matrix is mapped into a Triangular time-lag Matrix where T_{i,k}=S_{i,i+k}, where k is lag. The repetitive segments are converted to be parallel to the horizontal line in the T Matrix, shown in FIG. 2(C).

The repetitive lines may be broken into several lines, and some short horizontal lines may also be introduced due to noise. In order to improve the significant repetitive lines and remove short lines, erosion and dilation algorithms are applied one after another in this method. The resulting matrix illustrates a greater number of lines parallel to horizontal line, as shown in FIG. 2(D). Each line consists of several continuous frames.

The T Matrix is reformed into a Boolean Matrix due to the adjustable threshold, which is determined so that only 2% of Upper Matrix's elements can be higher than the chosen threshold. This results in well-defined repetitive lines parallel to horizontal line. Only the lines with a greater duration than 2 seconds are considered in further steps. If a certain line is repeated several times only one will be considered, but it will be noted, and receive a higher level of import.

Then, lines are inverted into corresponding song's segments. Only the segments with greater duration than 5 seconds are considered in further steps. If the shift between the end point of one segment and the start point of the other one is less than 0.6 seconds, those segments are merged into one. Inverted lines resulting in segments with duration less than 5 seconds are not considered. The result is a number of repetitive segments which best characterize the song.

For the convenience of future comparisons and searches, each segment is represented as an array of audio features. This is achieved by breaking up each segment into several half overlapped frames of 1.5 seconds, and the set of features is calculated for each frame. This results in a matrix for each segment which represents the audio features' rates of the certain segment frames and the order of the frames.

The similarity of different songs is defined by a comparison of those songs' ‘characterizing segments’ and order of the frames.

In accordance with yet another embodiment of the invention, a song's features-based map, or vector coherence mapping, is utilized for the detection of songs' similar frames/segments. The array of ‘N’ features' values describes each frame and may become a point in corresponding dimensional space. A polar representation is possible where each point is described by a vector. Each vector corresponds to the array of angles formed by the features' coordinate curves and the line linking the coordinate origin and the corresponding point of N-dimensional space. The vectors are normalized and their sources are coincided with polar space's origin.

The polar space's vectors are represented then as an N-level expanded tree. Each level represents a certain feature type. Each of the levels is divided into several ranges. The number of those ranges as well as the ranges' sizes can be preset or defined dynamically for each level.

The level's nodes contain information about the frame (song's ID, segment's ID, frame's ID, etc.) which corresponds to a unique set of values. This method is effective in identifying similar songs, even cover songs. In order to detect similar songs or cover songs to a certain song, a range of features must be defined for search by N-level tree. A comparison of selected songs' similarity depends on the defined range.

What is claimed is:

1. A computer-based method for recommending music to a user, comprising:
selecting a first song;
performing a mathematical analysis of audio content of said first song, wherein a set of features of said song are identified as a unique characterization of said first song;
comparing said unique characterization of said first song with a unique characterizations of a second song; and
recommending said second song based on said comparing wherein said unique characterization of said first song and said unique characterizations of a second song are similar.

2. The method of claim 1, wherein performing a mathematical analysis of audio content comprises:
dividing said first song into overlapped frames with a duration of at least one hundred milliseconds;
multiplying each frame by a window function;
processing said each of said frames with a Fast Fourier Transform; and
segmenting each of said frames obtained by a Fast Fourier Transform using thirty-six melbank coefficients, wherein each of said frames forms an array with thirty-six float elements.

3. The method of claim 2, wherein performing a mathematical analysis of audio content further comprises:
processing said array with a comparison algorithm to create a self-similarity matrix;
reforming said self-similarity matrix into a triangular time-lag matrix;
aggregating elements of said triangular time-lag matrix;
processing said aggregated elements using an averaging algorithm to form an averaged matrix; and
reforming said averaged matrix into a Boolean matrix due to an adjustable threshold, wherein said Boolean matrix forms a vector.

4. The method of claim 3, wherein comparing said unique characterization of said first song with a unique characterizations of a second song comprises:
comparing said vector with an existing vector for said second song.

5. The method of claim 1, wherein performing a mathematical analysis of audio content comprises:
dividing said first song into overlapped frames with a duration of at least one hundred milliseconds;
processing said each of said frames with a Constant Q Transform; and
extracting thirty-six notes from each of said frames obtained by a Constant Q Transform, wherein each of said frames forms an array with thirty-six float elements.

6. The method of claim 5, wherein performing a mathematical analysis of audio content further comprises:
processing said array with a comparison algorithm to create a self-similarity matrix;
processing each element of said self-similarity matrix using an averaging algorithm to form an averaged matrix;
mapping said averaged matrix onto a triangular time-lag matrix;
reforming said triangular time-lag matrix into a Boolean matrix due to an adjustable threshold; and
filtering lines from said Boolean matrix into a characterizing matrix, wherein said characterizing matrix indicates characteristic segments of said first song.

7. The method of claim 6, wherein comparing said unique characterization of said first song with a unique characterizations of a second song comprises:
comparing said characterizing matrix of said first song with an existing characterizing matrix of said second song.

8. The method of claim 1, wherein performing a mathematical analysis of audio content comprises:
dividing said first song into overlapped frames with a duration of at least one hundred milliseconds;
multiplying each frame by a window function;
processing said each of said frames with a Fast Fourier Transform;
segmenting each of said frames obtained by a Fast Fourier Transform using thirty-six melbank coefficients, wherein each of said frames forms an array of ‘N’ features;
mapping each of said arrays to a point in corresponding dimensional space; and
mapping each of said points to a vector in polar space of N-dimensions.

9. The method of claim 8, wherein comparing said unique characterization of said first song with a unique characterizations of a second song comprises:
using coherence vectors, wherein said coherence vectors are at least one vector of said first song in N-dimensional polar space and at least one vector of said second song in N-dimensional polar space.

10. The method of claim 1, wherein performing a mathematical analysis of audio content comprises:
dividing said first song into overlapped frames with a duration of at least one hundred milliseconds;
processing said each of said frames with a Constant Q Transform;
extracting thirty-six notes from each of said frames obtained by a Constant Q Transform, wherein each of said frames forms an array of ‘N’ features;
mapping each of said arrays to a point in corresponding dimensional space; and
mapping each of said points to a vector in polar space of N-dimensions.

11. The method of claim 10, wherein comparing said unique characterization of said first song with a unique characterizations of a second song comprises:
using coherence vectors, wherein said coherence vectors are at least one vector of said first song in N-dimensional polar space and at least one vector of said second song in N-dimensional polar space.

12. A method for characterizing the digital composition of audio content in a song, comprising:
selecting a song;
dividing said song into one or more segments;
performing a mathematical analysis of audio content of each of said one or more segments of said song, wherein features of each of said one or more segments are identified; and
compiling a set of features for said song based on said mathematical analysis, wherein said set of features provides a unique characterization of said song.

13. The method of claim 12, wherein performing a mathematical analysis of audio content comprises:
dividing said first song into overlapped frames with a duration of at least one hundred milliseconds;
multiplying each frame by a window function;
processing said each of said frames with a Fast Fourier Transform; and
segmenting each of said frames obtained by a Fast Fourier Transform using thirty-six melbank coefficients, wherein each of said frames forms an array with thirty-six float elements.

14. The method of claim 13, wherein performing a mathematical analysis of audio content further comprises:
processing said array with a comparison algorithm to create a self-similarity matrix;
reforming said self-similarity matrix into a triangular time-lag matrix;
aggregating elements of said triangular time-lag matrix;
processing said aggregated elements using an averaging algorithm to form an averaged matrix; and
reforming said averaged matrix into a Boolean matrix due to an adjustable threshold, wherein said Boolean matrix forms a vector.

15. The method of claim 14, wherein comparing said unique characterization of said first song with a unique characterizations of a second song comprises:
comparing said vector with an existing vector for said second song.

16. The method of claim 12, wherein performing a mathematical analysis of audio content comprises:
dividing said first song into overlapped frames with a duration of at least one hundred milliseconds;
processing said each of said frames with a Constant Q Transform; and
extracting thirty-six notes from each of said frames obtained by a Constant Q Transform, wherein each of said frames forms an array with thirty-six float elements.

17. The method of claim 16, wherein performing a mathematical analysis of audio content further comprises:
processing said array with a comparison algorithm to create a self-similarity matrix;
processing each element of said self-similarity matrix using an averaging algorithm to form an averaged matrix;
mapping said averaged matrix onto a triangular time-lag matrix;
reforming said triangular time-lag matrix into a Boolean matrix due to an adjustable threshold; and
filtering lines from said Boolean matrix into a characterizing matrix, wherein said characterizing matrix indicates characteristic segments of said first song.

18. The method of claim 17, wherein comparing said unique characterization of said first song with a unique characterizations of a second song comprises:
comparing said characterizing matrix for said first song with an existing characterizing matrix for said second song.

19. A system for recommending music to a user, comprising:
at least one server comprising:
a first database storing a first song based upon a user's musical interest data;
a second database storing a characterization of said first song based on a mathematical analysis of said first song; and
a recommendation engine operative to, perform said mathematical analysis of audio content of said first song, compare said characterization with a set of characterizations from other songs, and recommend a second song based on similar characterizations between said first song and said second song;
at least one client device comprising:
an input device to input said user's musical interest data; and
a display to provide said recommendation to said user; and,
a communication link providing communication between the at least one server and the at least one client device.
